(19) United States
(12) Patent Application Publication
(10) Pub. No.: US 2005/0121559 A1
(43) Pub. Date: Jun. 9, 2005

(54) Simplified pipe support assembly

(76) Inventor: Robert W. King, Santa Clarita, CA (US)

Correspondence Address: Fulwider Patton Lee & Utecht LLP;Atten: Alan C. Rose, Howard Hughes Center, Tenth Floor 6060 Center Drive, Los Angeles, CA, 90045, US

(21) Appl. No.: 10/730,844

(22) Filed: Dec. 9, 2003

(51) Int. Cl. F16L 3/22

(52) U.S. Cl. 248/68.1

(57) ABSTRACT

A plastic pipe support assembly includes a pair of snap-on wall brackets or fittings with each bracket or fitting including a base portion and a snap-on, pipe receiving portion. The base portion includes holes for receiving nails or screws for mounting to studs in a building, for example; and the snap-on pipe receiving portion includes a pair of jaws for extending around a support pipe, with the opening between the jaws having a spacing which is less than the diameter of the support pipe so that the support pipe may be snapped into the jaws, and held firmly in place. One or more pipe-to-pipe fittings may be provided with each fitting having a pair of pipe receiving jaws, for mounting water pipes to the support pipe. The support pipe and the brackets or fittings may be all formed of the same type of plastic as the water pipe, such as polyvinyl chloride, or chlorinated polyvinyl chloride. Plastic solvent may be employed to bond the pipes and fittings together.

### FIELD OF THE INVENTION

This invention relates to pipe supports, principally for plastic pipe.

### BACKGROUND OF THE INVENTION

The purpose of the present invention is the support of plumbing pipes in the walls of structures. If pipes are not supported, they may shake and rattle when faucets are turned on and off and, without support, the weight of water in the pipes may cause pipes to sag and be damaged. Also, when the pipes protrude through the walls, the supports keep pipes lined up during the installation of drywall and also hold the pipes from behind, enabling the plumber to attach end valves on the outside of the wall.

In accordance with prior practice various metal support straps are sold with holes along their length. These supports are nailed between wall studs, and pipes are wired or clamped to the metal straps. Some metal supports telescope to fit between studs and others are cut with a hack saw to fit between the studs. If a metal support strap is not used, a section of 2×4 inch scrap lumber is cut and nailed between studs and notches cut for the pipes. Then the pipes are secured to the 2×4 inch support using metal tape.

Regarding prior art patents, the following patents show a variety of pipe and rod supports which have been used heretofore:

| | | |
|---|---|---|
| 998,112 | 5,542,631 | 5,943,985 |
| 1,056,596 | 5,547,152 | 6,227,757 |
| 2,801,064 | D 375,890 | 6,296,211 |
| 3,363,864 | 5,595,363 | 6,367,744 |
| 4,202,090 | 5,791,607 | 6,390,421 |
| 4,695,019 | 5,833,179 | 6,543,731 |
| D 295,725 | 5,906,341 | 6,554,231 |
| D 355,582 | | |

In reviewing the prior art patents the —731 patent is of interest in disclosing the use of plastic pipe support elements. However, the disclosed arrangements are relatively rigid and inflexible, making additions and reworking difficult and inconvenient.

### SUMMARY OF THE INVENTION

In accordance with an illustrative preferred embodiment of the invention a plastic support pipe is mounted to a structure, for example between two 2×4 inch studs, by two plastic snap-on clip fittings. Each of these fittings includes a base portion having holes for receiving mounting nails or screws, and an integral, partially open, snap-on clip portion for receiving the support pipe. A double snap-on plastic clip fitting includes a first partially open snap-on clip portion for mounting on the support pipe, and a second integral, partially open, snap-on clip portion for receiving a fluid flow system pipe, such as a water pipe.

The pipe-to-pipe double snap fittings are made in a combination of sizes to snap onto various sizes and types of pipes When the wall-to-pipe and pipe-to-pipe snap fittings are made of PVC (polyvinyl chloride) or CPVC (chlorinated polyvinyl chloride) and the water piping is PVC or CPVC, the support and water pipe system may be solvent welded together to make it rigid.

Concerning installation, a length of common plastic pipe is cut to fit between 2×4 inch studs of a wall. A wall-to-pipe snap fitting is nailed or screwed to the 2×4 stud on each side of the space where a water pipe is to be mounted. The cut length of pipe is snapped into the mounted wall-to-pipe fittings. A pipe-to-pipe snap fitting is snapped onto the support pipe and the water pipe is snapped into the same pipe-to-pipe fitting. PVC or CPVC solvent cement may be applied to pipes and clamps to make the support system rigid.

Advantages of the system include the fact that a plumber is using familiar tools and materials to make a support system for his pipes. Cutting pipe to fit between the studs is easy and requires no precise measuring. The whole system snaps together and may be unsnapped easily for reworking. The system is corrosion proof as no metallic parts are used. The system does not damage pipes as the support materials used may be the same as the water pipe materials. The system when made of CPVC or PVC may be solvent welded together with pipes making a rigid assembly.

The pipe-to-pipe fittings may include one snap-on portion for securing to a ½ inch support pipe, and a second integral snap-on portion for securing to a ¾ inch water pipe, by way of example.

The wall-to-pipe snap-on fittings as discussed above may be employed with a support pipe; and any suitable pipe-to-pipe fitting may be employed to support a water pipe from the support pipe. In some cases, a water pipe may be secured directly to a wall-to-pipe fitting.

The fittings and support pipes are preferably made from the same type of plastic as the water pipe to avoid damage to the water pipe and to permit easy solvent bonding. In addition the short lengths of support pipe may be available as scrap from pipe length cut to water pipe usage.

The “jaws” of the snap-on portion of the fittings may define a predetermined diameter for receiving a pipe; and the opening of the jaws should be slightly less than this diameter, preferably in the order of three quarters of the diameter. More generally, the opening of the jaws of the fitting will vary depending on the flexibility of the plastic material and its thickness, but should be such that a pipe can be snapped into engagement with the fitting with normal force of a few pounds up to 5, 10 or even 15 pounds.

It is also desirable that the axial extent of the jaws is substantial, for example more than one-half the outer diameter of the pipe to be held by the jaws, to accommodate support pipes of varying lengths.

Other objects, features and advantages of the invention will become apparent from a consideration of the following detailed description and from the accompanying drawings.

### BRIEF DESCRIPTION OF THE DRAWINGS

FIG. 1 shows a pipe support system mounted on the studs within a wall, illustrating the principles of the invention;

FIG. 2 shows an alternative application of the principles of the invention;

FIG. 3 shows a wall-to-pipe snap fitting;

FIG. 4 is a perspective view of a double, pipe-to-pipe snap fitting; and

FIG. 5 shows a pipe-to-pipe snap fitting similar to that of FIG. 4, but adopted for use with different size pipes.

While the specification describes particular embodiments of the present invention, those of ordinary skill can devise variations of the present invention without departing from the inventive concept.

### DETAILED DESCRIPTION OF THE PREFERRED EMBODIMENTS

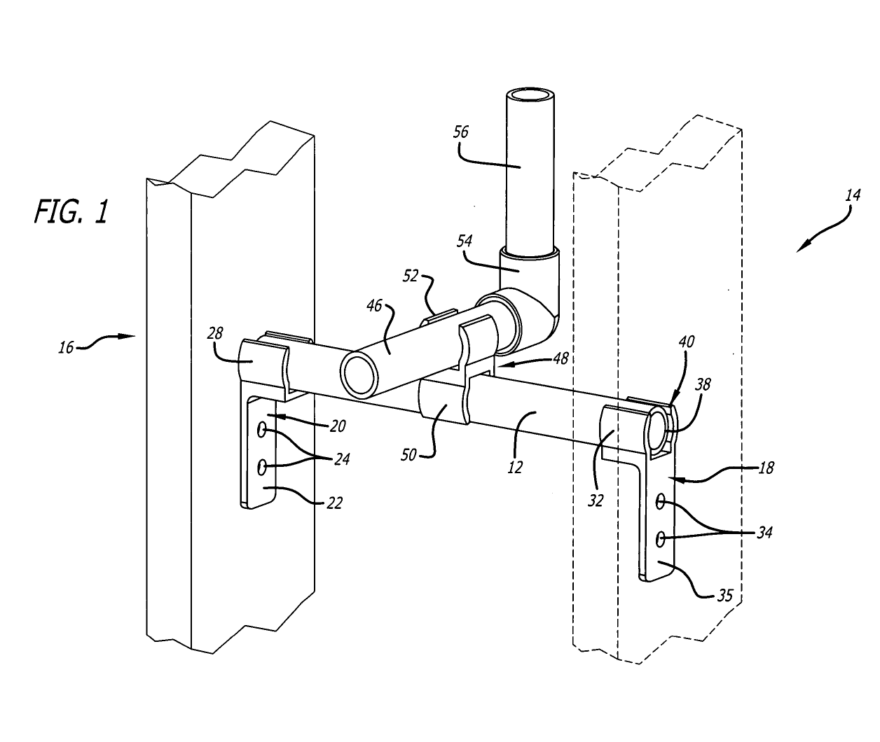

Referring more particularly to the drawings, FIG. 1 shows a support pipe 12 extending between two supports 14 and 16 which may be 2×4 inch studs within a wall. Two wall-to-pipe fittings 18 and 20 are provided, with the base portion 22 of fitting 20 being provided with holes 24 to receive nails or screws to fasten the fitting 20 to the stud 16.

At the upper end of fitting 20 is an integral, partially open snap-on clip portion 28 into which one end of the support pipe 12 may be snapped.

The other end of support pipe 12 may be snapped into the upper portion 32 of fitting 18. Openings 34 in fitting 18 serve to receive fasteners to hold the base 35 of fitting 18 to the stud 14. It may be noted that the length of support pipe 12 need not be exact, and the end 38 of support pipe 12 is shown spaced back slightly from the end 40 of circular portion 32 which faces stud 14. With the clip-on portions 28 and 32 on the fittings 18 and 20 having a substantial axial extent, the length of the support pipe need not be precise but may be merely roughly measured by the plumber or other workman making the installation.

The water pipe 46 may be mounted to the support pipe 12 by the double snap-on clip fitting 48 having a lower snap-on portion 50 mounted onto support pipe 12, and an upper snap-on portion 52 engaging the water pipe 46. The water (or other fluid) pipe 46 mates with a conventional “L” fitting 54 to which is mounted a vertical pipe 56 forming part of the water system of a structure which includes the studs 14 and 16.

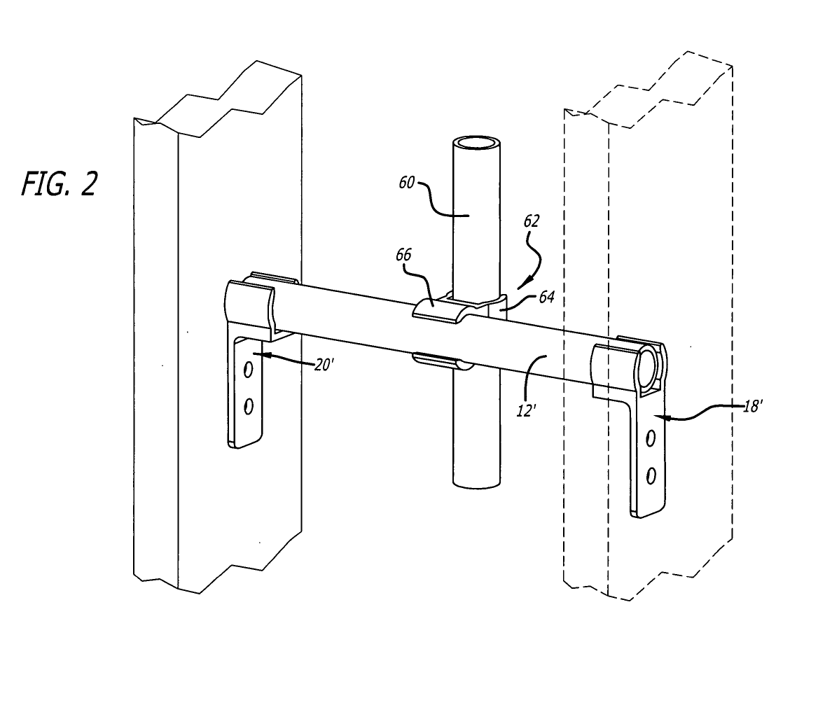

FIG. 2 is similar to FIG. 1 in some respects including the two wall-to-pipe fittings 18′ and 20′ and the support pipe 12′. However, the vertically extending water pipe 60 has a greater diameter than support pipe 12; and the fitting 62 accordingly has different size snap-on portions 64 and 66, with the snap-on portion 64 having a larger diameter to mate with the larger diameter water pipe 60.

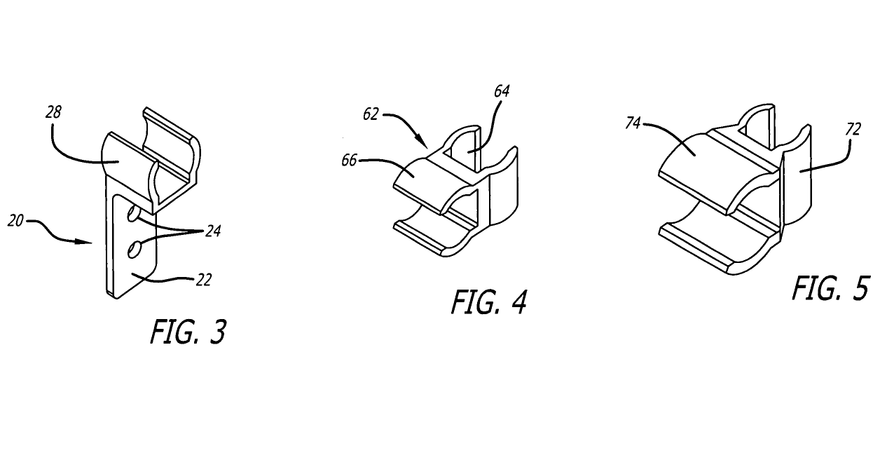

FIG. 3 is a perspective view of fitting 20 of FIG. 1, with the support pipe 12 removed. In FIG. 3 the upper snap-on portion 28 may be seen to advantage, and it has a generally circular configuration with one portion of the circular clip on portion being partially open. The open portion is preferably greater than one-quarter of the circumference of the pipe to be contained in the snap-on portion, and is preferably less than one-half of the diameter, so a positive holding action is obtained.

FIG. 4 is a perspective showing of a pipe-to-pipe clip-on fitting 62 with two snap-in structures 64 and 66 mounted back to back. Again, the open portion is somewhat less than one-half the diameter of the pipe to be mounted but greater than one-quarter of this diameter, to provide firm clip-on action when a pipe is pushed against the open jaws.

The pipe-to-pipe fitting embodiment of FIG. 5 is similar to that of FIG. 4, but includes a rear snap-on portion 72 dimensioned to fit a fairly small support pipe, such as nominal one-half inch pipe. The front snap on portion 74, however, is dimensioned to fit a larger pipe such as a nominal three-quarters inch pipe, or a one inch pipe.

Concerning dimensions, in one practical embodiment which has been successfully employed with ½ inch pipe, the base portion 22 was 0.7 inch wide and 0.1 inch thick; the entire height of the unit was 2.21 inches high; the inner diameter across between the curved portions of the fitting was 0.622 inch, and the outer diameter of the “jaws” was 0.830 inch. The axial length of the pipe receiving opening was 0.70 inch, and thus had an axial extent greater than ½ of the inner diameter (or the O.D. of the support pipe). The holes for screws or nails were 0.20 inch in diameter. Regarding the pipe-to-pipe fitting for coupling a one-half inch support pipe to a one-half inch water pipe, the inner and outer diameters of the “jaws” were the same as noted above for the pipe-to-wall fittings. It may be noted in passing that the opening for receiving pipes may be squared off as shown, or may be rounded at the side of the fittings opposed to the open “jaws”.

It is to be understood of course that the specific dimensions set forth above are merely representative of one preferred embodiment, and different dimensions would be employed for different size pipe and for different applications.

Concerning materials, the preferred material for the fittings is chlorinated polyvinyl chloride, which is widely used for water pipes. Other plastic materials may also be used.

In some cases when it is desired to make the pipe assembly in a permanent configuration the support pipes may be solvent welded to one-another, and to the water pipes. In other cases, where modification of the system may be contemplated or when it is desired to allow for expansion and contraction of hot water pipes, the solvent welding need not be used, leaving the pipe assembly capable of being snapped apart, and reworked.

In the foregoing detailed description and in the drawings, illustrative preferred embodiments of the invention have been described in detail. Various changes and modifications can, however, be accomplished without departing from the spirit and scope of the invention. Thus, by way of example and not of limitation, while it is preferred that the fittings be molded in one piece, they may be molded in more than one piece, and solvent welded together. Also, it is to be understood that the dimensions given were for standard one-half inch plastic pipe, and that for other size pipe, other comparable dimensions would be used. Also, changes in the thickness, width and length of the base members fastener holes may be made; and the base members could even be circular instead of rectangular, for examples. Accordingly, the present invention is not limited to the precise embodiments as shown in the drawings and described in detail hereinabove.

1. A system for mounting plastic pipes comprising:
a hollow plastic support pipe having an outer diameter;
first and second plastic snap fittings each including a base portion having openings for receiving screws or nails, and an integral partially open snap-on clip portion for receiving the hollow, support pipe;
a double snap-on plastic clip fitting having a first partially open snap-on clip portion for mounting on the hollow plastic support pipe, and a second integral, partially open, snap-on clip portion arranged non-parallel to said first partially open snap-on clip portion for receiving a fluid flow system pipe; and
said snap-on clip portions being partially open and having outwardly extending jaws, the space between said jaws extends slightly less than the outer diameter of said support pipe, and wherein said space between the jaws is defined by a rectangular portion transitioning into an arcuate bend in each jaw;
whereby said support pipe may be cut to a length slightly less than the distance between two studs, said base portion of said fittings may be secured in place on said studs, said support pipe snapped into said clip-on portion, and said double clip fitting snapped onto both the support pipe and a fluid flow system pipe to simply and securely hold the fluid flow system pipe in place.

2. A system as defined in claim 1 wherein at least one of the pipes is bonded to one of said snap-on clips by plastic solvent.

3. A system as defined in claim 1 wherein all of said pipes and fittings are formed of PVC or CPVC.

4. A system as defined in claim 1 wherein said fittings may be snapped out of engagement with the mating pipe independently of one another, to modify said pipe support system.

5. A system as defined in claim 1 wherein the two snap-on clip portions of the double fitting are of different sizes to mate with pipes of different diameters.

6. A system as defined in claim 1 wherein the open space between said jaws is about three-quarters of said diameter.

7. A support or fitting as defined in claim 1 wherein the axial extent of said jaws is greater than one-half of said outer diameter.

8. A support or fitting for receiving a plastic pipe having a predetermined outer diameter said support or fitting comprising:
a plastic base portion having holes there through for receiving nails or screws;
a plastic snap-on clip portion of generally circular configuration ;
said snap-on portion being partially open and having outwardly extending U-shaped jaws, wherein the space between said jaws is slightly less than the outer diameter of the plastic pipe and has a rectangular shape leading to an arcuate shape of said jaws; and
said base portion and said snap-in clip portion being integrally molded of plastic.

9. A support or fitting as defined in claim 8 wherein the open space between said jaws is about three-quarters of said diameter.

10. A support or fitting as defined in claim 8 wherein the axial extent of said jaws is greater than one-half of said outer diameter.

11. A system for mounting plastic pipes comprising:
a hollow plastic support pipe having an outer diameter;
first and second plastic snap fittings each including a base portion for securing to a structure, and an integral partially open snap-on clip portion for receiving the hollow, support pipe;
a double snap-on plastic clip fitting having a first partially open snap-on clip portion for mounting on the hollow plastic support pipe, and a second integral, partially open, snap-on clip portion arranged perpendicular to said first partially open snap-on clip portion for receiving a fluid flow system pipe; and
said snap-on clip portions being partially open with a rectangular shape transitioning into outwardly extending arcuate shaped jaws to snap onto and receive said support pipe.

12. A system as defined in claim 11 wherein at least one of the pipes is bonded to one of said snap-on clip portions by plastic solvent.

13. A system as defined in claim 11 wherein all of said pipes and fittings are formed of PVC or CPVC.

14. A system as defined in claim 11 wherein said fittings may be snapped out of engagement with the mating pipe independently of one another, to modify said pipe support system.

15. A system as defined in claim 11 wherein the two snap-on clip portions of the double fitting are of different sizes to mate with pipes of different diameters.

16. A support or fitting as defined in claim 11 wherein the open space between said jaws is about three-quarters of said diameter.

17. A support or fitting as defined in claim 11 wherein the axial extent of said jaws is greater than one-half of said outer diameter.

18. A system for mounting plastic pipes as defined in claim 11 wherein said base portion of each of said snap fittings has holes for receiving nails or screws.

19. A pipe system comprising:
a wall-to-pipe fitting including a base portion for mounting to a wall or studs, and a snap-on portion having a rectangular shape open portion leading to arcuate shape open jaws for receiving a support pipe;
a support pipe mounted into said snap-on portion of said fitting; and
a double snap-on pipe-to-pipe fitting for securing a fluid flow pipe to said support pipe wherein pipes held by said double snap-on pipe-to-pipe fitting are not parallel to each other.

20. A pipe system as defined in claim 19 wherein said support pipe has a predetermined outer diameter, and wherein said jaws are spaced apart by a distance slightly less than said diameter to permit said support pipe to snap into said snap-on portion.
